(19) United States
(12) Patent Application Publication
(10) Pub. No.: US 2012/0275712 A1
(43) Pub. Date: Nov. 1, 2012

(54) IMAGE PROCESSING DEVICE, IMAGE PROCESSING METHOD, AND PROGRAM

(75) Inventors: Seijiro Inaba, Kanagawa (JP); Atsushi Kimura, Tokyo (JP); Ryota Kosakai, Tokyo (JP)

(73) Assignee: Sony Corporation, Tokyo (JP)

(21) Appl. No.: 13/423,873

(22) Filed: Mar. 19, 2012

(30) Foreign Application Priority Data
Apr. 28, 2011 (JP) 2011-100835

(51) Int. Cl. G06K 9/46

(52) U.S. Cl. 382/201

(57) ABSTRACT

There is provided an image processing device including a feature point detection processing unit configured to detect a feature point from an image, and a feature quantity generation processing unit configured to compare a pixel difference value of two pixels in an image region having a position of the detected feature point as a reference with a threshold and generate binary information indicating a result of comparison as a component of feature quantities corresponding to the feature point.

### BACKGROUND

The present technology relates to an image processing device, an image processing method, and a program. More specifically, the present technology is directed to matching identical objects between two images with high accuracy and with a low processing cost.

Conventionally, in various circumstances such as when an object is searched for from an image, when a moving object is detected from an image sequence, or when alignment of a plurality of images is performed, it has become necessary to match identical objects between the plurality of images.

As a method of matching identical objects, a method called block matching or a feature point-based method is used.

In block matching, a given image is split into block regions, and SAD (Sum of Absolute Difference) or NCC (Normalized Cross Correlation) is computed. Then, on the basis of the computed SAD or NCC, a region having high similarity to each block is searched for from another image. This method involves quite a high computational cost as it is necessary to compute the similarity between block regions while gradually shifting the block center coordinates within the search range. Further, as it is necessary to search for a corresponding position even in a region that is difficult to be matched, the processing efficiency is low.

In the feature point-based method, a position that is easily matched, such as a corner of an object or a picture in an image, is first detected as a feature point. Methods of detecting feature points come in a variety of types. Representative methods include a Harris corner detector (see C. Harris, M. J. Stephens, “A combined corner and edge detector”, In Alvey Vision Conference, pp. 147-152, 1988), FAST (see Edward Rosten, Tom Drummond, “Machine learning for high-speed corner detection”, European Conference on Computer Vision (ICCV), Vol. 1, pp. 430-443, 2006), and DoG (Difference of Gaussian) maxima (see David G. Lowe, “Distinctive Image Features from Scale-Invariant Keypoints”, International Journal of Computer Vision (IJCV), Vol. 60, No. 2, pp. 91-110, 2004). Next, for the detected feature point, a corresponding feature point in another image is searched for. In this manner, as only a feature point is the target to be searched for, the processing efficiency is quite high. As a method of matching identical feature points, similarity is computed for each local region having a feature point as a center in an image using SAD or NCC, and a feature point having the highest similarity is determined to be a matching point. As another matching method, a feature point is substituted by feature quantities (also referred to as a feature vector) describing a local region having the feature point as a center, and similarity between feature quantities is determined Then, a feature point with the highest similarity is determined to be a matching point. Examples of such method include SIFT (Scale Invariant Feature Transform, see David G. Lowe, “Distinctive Image Features from Scale-Invariant Keypoints”, International Journal of Computer Vision (IJCV), Vol. 60, No. 2, pp. 91-110, 2004) and SURF (Speeded Up Robust Features, see Herbert Bay, Andreas Ess, Tinne Tuytelaars, Luc Van Gool, “SURF: Speeded Up Robust Features”, Computer Vision and Image Understanding (CVIU), Vol. 110, No. 3, pp. 346-359, 2008).

### SUMMARY

By the way, in a plurality of images from which identical objects are matched, there may be cases where, the brightness of the identical objects differs due to a change in camera parameters such as a shutter speed or a diaphragm or a change in brightness of the environmental light. In such cases, unless a method of eliminating the influence of the difference in brightness through a normalization process is used, a matching error may occur due to the difference in brightness. For example, when a method in which a normalization process like Sum of Absolute Difference (SAD) is not performed is used, the SAD may increase due to the difference in brightness even in a region having high similarity, with the result that a region having high similarity cannot be detected accurately. For example, a case where a plurality of images are captured by swinging an imaging device to generate a panoramic image will be described. When a plurality of images are captured by swinging an imaging device, the brightness of identical objects could differ if a change in brightness occurs due to the shutter speed having been changed to prevent blown out highlights or blocked up shadows in response to a change in state from the direct light condition to the backlight condition or from the backlight condition to the direct light condition, or due to the sun covered by a cloud while the camera is swung. Therefore, even identical objects will have an increased SAD due to the difference in brightness, with the result that the identical objects cannot be determined accurately. Thus, it is difficult to generate a panoramic image by accurately joining images so that the object image will have no missing parts or overlapping parts.

Meanwhile, when NCC is used or when feature quantities (a feature vector) generated using SIFT or SURF are normalized on the basis of the length of the vector and are used as a unit vector, it is possible to match identical objects by eliminating the influence of the change in brightness. However, as the normalization process involves a root operation/division, the processing cost could be high. In addition, as the components of the feature quantities differ from feature point to feature point, the range of a number that serves as a denominator in the normalization computation is quite wide. Thus, even when the inverse of the denominator is attempted to be tabulated and changed into multiplication, a memory cost needed for the tabulation could be high, which is thus not realistic.

In light of the foregoing, it is desirable to provide an image processing device, an image processing method, and a program that can generate feature quantities, which are used for matching identical objects between two images, with high accuracy and with a low processing cost.

According to a first aspect of the present technology, there is provided an image processing device including a feature point detection processing unit configured to detect a feature point from an image, and a feature quantity generation processing unit configured to compare a pixel difference value of two pixels in an image region having a position of the detected feature point as a reference with a threshold and generate binary information indicating a result of comparison as a component of feature quantities corresponding to the feature point.

According to this technology, a feature point is detected from an image by the feature point detection processing unit. In the feature quantity generation processing unit, a pixel difference value of two pixels in an image region having a position of the detected feature point as a reference is compared with a threshold. For example, a pixel difference value of two adjacent pixels, a pixel difference value of two adjacent pixels located along a circumference having the position of the feature point as a center, a pixel difference value of two pixels determined in advance through learning, or the like is compared with a threshold “0.” Further, binary information indicating the result of comparison is used as a component of the feature quantities.

In addition, for a feature point detected from a first image, feature quantities that are most similar to feature quantities corresponding to the feature point are searched for from among feature quantities corresponding to feature points detected from a second image, so that a feature point in the second image corresponding to the feature point detected from the first image is detected. In the search for the most similar feature point, an exclusive OR operation of the feature quantities corresponding to the feature point detected from the first image and the feature quantities corresponding to the feature point detected from the second image is performed, and feature quantities that are most similar are retrieved on the basis of the operation result. Further, a transformation matrix for performing image transformation between the first image and the second image is computed through robust estimation from a correspondence relationship between the feature point detected from the first image and the feature point in the second image corresponding to the feature point detected from the first image.

According to a second aspect of the present technology, there is provided an image processing method including detecting a feature point from an image, and comparing a pixel difference value of two pixels in an image region having a position of the detected feature point as a reference with a threshold, and generating binary information indicating a result of comparison as a component of feature quantities corresponding to the feature point.

According to a third aspect of the present technology, there is provided a program for causing a computer to execute the procedures of detecting a feature point from an image, and comparing a pixel difference value of two pixels in an image region having a position of the detected feature point with a threshold, and generating binary information indicating a result of comparison as a component of feature quantities corresponding to the feature point.

Note that the program of the present technology is a program that can be provided to a computer that can execute various program codes, by means of a storage medium provided in a computer-readable format, a communication medium, for example, a storage medium such as an optical disc, a magnetic disk, or semiconductor memory, or a communication medium such as a network. When such a program is provided in a computer-readable format, a process in accordance with the program is implemented on the computer.

According to the present technology described above, a feature point is detected from an image. Then, a pixel difference value of two pixels in an image region, which has the position of the detected feature point as a reference, is compared with a threshold, and binary information representing the result of comparison is generated as a component of the feature quantities corresponding to the feature point. Therefore, it becomes possible to generate feature quantities used for matching identical objects between two images with high accuracy and with a low processing cost.

### BRIEF DESCRIPTION OF THE DRAWINGS

FIG. 1 is a diagram showing a schematic configuration of an imaging device;

FIG. 2 is a diagram exemplarily showing the configuration of a portion in which an object matching process is performed in an image processing unit;

FIG. 3 is a diagram showing a case where feature quantities are generated using each pixel in a rectangular local region;

FIG. 4 is a diagram showing another case where feature quantities are generated using each pixel in a rectangular local region;

FIG. 5 is a diagram showing the relationship between a circle having a feature point as a center and a corner;

FIG. 6 is a diagram showing a case where feature quantities are generated using pixels along a circumference around a rectangular local region;

FIG. 7 is a diagram showing a case where feature quantities are generated using pixels along multiple circumferences around a rectangular local region; and

FIG. 8 is a diagram showing a case where feature quantities are generated using pixels specified through learning.

### DETAILED DESCRIPTION OF THE EMBODIMENTS

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted. Note that the description will be given in the following order.

1. Schematic Configuration of Imaging Device

2. Configuration of Portion in which Object Matching Process is Performed in Image Processing Unit

3. Feature Quantity Generation Process

### <1. Schematic Configuration of Imaging Device>

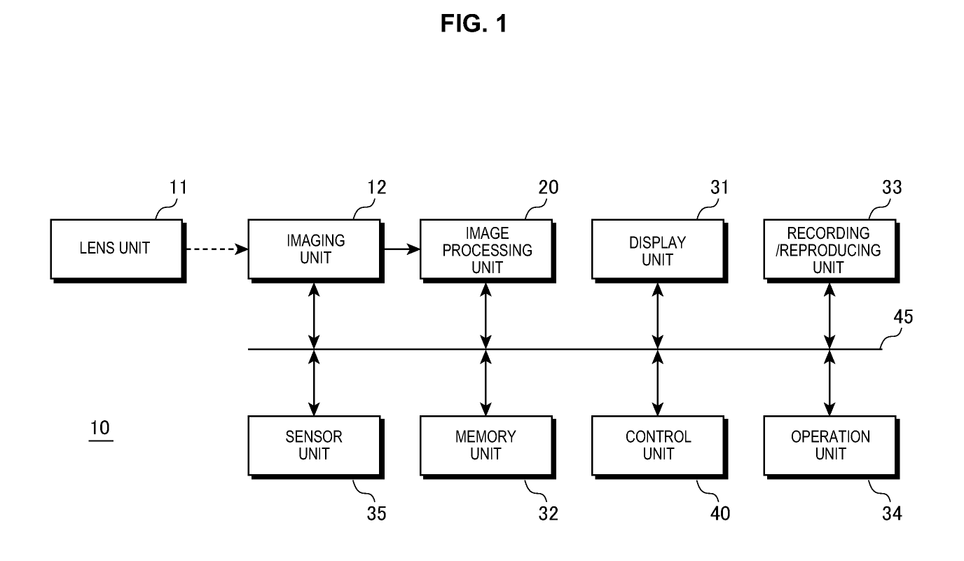

FIG. 1 is a diagram showing a schematic configuration of an imaging device that uses an image processing device in accordance with an embodiment of the present technology.

An imaging device 10 includes a lens unit 11, an imaging unit 12, an image processing unit 20, a display unit 31, a memory unit 32, a recording device unit 33, an operation unit 34, a sensor unit 35, and a control unit 40. In addition, each unit is connected via a bus 45.

The lens unit 11 includes a focus lens, a zoom lens, a diaphragm mechanism, and the like. The lens unit 11 drives the lens in accordance with an instruction from the control unit 40, and forms an optical image of a subject on an image plane of the imaging unit 12. In addition, the lens unit 11 adjusts the diaphragm mechanism so that the optical image formed on the image plane of an image sensor 12 has desired brightness.

The imaging unit 12 includes an image sensor such as a CCD (Charge Coupled Device) image sensor or a CMOS (Complementary Metal Oxide Semiconductor) image sensor, a driving circuit that drives the image sensor, and the like. The image sensor 12 performs photoelectric conversion to convert an optical image formed on the image plane of the image sensor into an electrical signal. Further, the imaging unit 12 removes noise from the electrical signal and performs analog/digital conversion, and further generates an image signal and outputs it to the image processing unit 20 or the memory unit 32 via the image processing unit 20.

The image processing unit 20 performs, on the basis of a control signal from the control unit 40, various camera signal processing on the image signal or performs an encoding process, a decoding process, or the like on the image signal. Further, the image processing unit 20 performs, on the basis of a control signal from the control unit 40, an object matching process or performs image processing using the result of the matching process. The object matching process and the image processing using the result of the matching process are described below.

The display unit 31 includes liquid crystal display elements and the like, and displays an image on the basis of the image signal processed by the image processing unit 20 or the image signal stored in the memory unit 32.

The memory unit 32 includes semiconductor memory such as DRAM (Dynamic Random Access Memory). The memory unit 32 temporarily stores image data to be processed by the image processing unit 20, image data processed by the image processing unit 20, control programs and various data in the control unit 40, and the like.

For the recording device unit 33, a recording medium such as semiconductor memory like flash memory, a magnetic disk, an optical disc, or a magneto-optical disk is used. The recording device unit 33 records an image signal, which has been generated by the imaging unit 12 during an imaging process, encoded by the image processing unit 20 with a predetermined encoding method, and stored in the memory unit 32, for example, on the recording medium. In addition, the recording device unit 33 reads the image signal recorded on the recording medium into the memory unit 32.

The operation unit 34 includes an input device such as a hardware key like a shutter button, an operation dial, or a touch panel. The operation unit 34 generates an operation signal in accordance with a user input operation, and outputs the signal to the control unit 40.

The sensor unit 35 includes a gyro sensor, an acceleration sensor, a geomagnetic sensor, a positioning sensor, or the like, and detects various information. Such information is added as metadata to the captured image data, and is also used for various image processing or control processes.

The control unit 40 controls the operation of each unit on the basis of an operation signal supplied from the operation unit 34, and controls each unit so that the operation of the imaging device 10 becomes an operation in accordance with a user operation.

<2. Configuration of Portion in which Object Matching Process is Performed in Image Processing Unit>

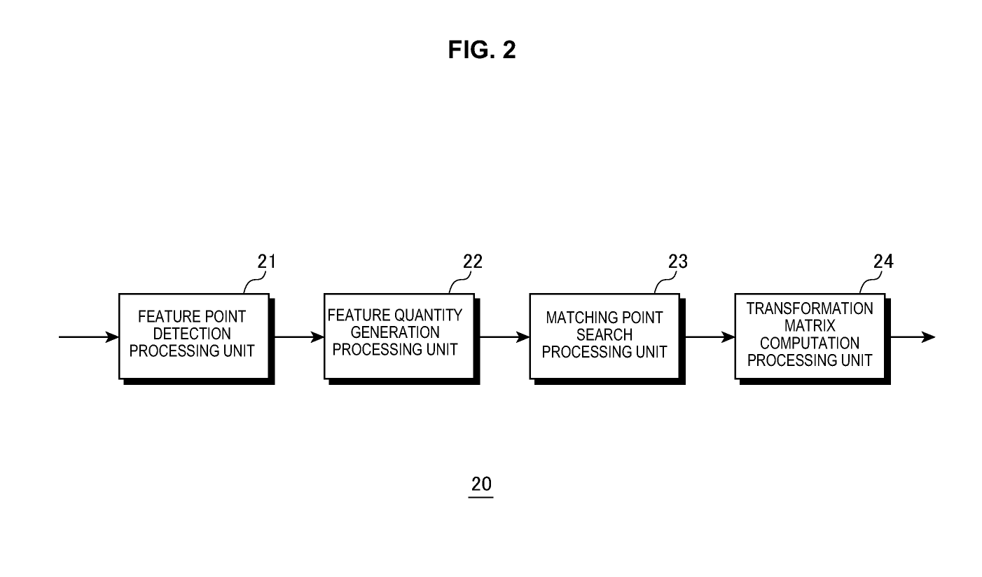

FIG. 2 exemplarily shows a configuration of a portion in which an object matching process is performed in the image processing unit 20. The image processing unit 20 includes a feature point detection processing unit 21 and a feature quantity generation processing unit 22 that generates feature quantities used for a process of matching identical objects between two images. Further, the image processing unit 20 includes a matching point search processing unit 23 and a transformation matrix computation processing unit 24 to match identical objects on the basis the feature quantities.

The feature point detection processing unit 21 performs a process of detecting a feature point from a captured image. The feature point detection processing unit 21 detects a feature point using, for example, a Harris corner detector, FAST, or DoGmaxima. Alternatively, the feature point detection processing unit 21 may detect a feature point using a Hessian filter or the like.

The feature quantity generation processing unit 22 generates feature quantities that describe a local region having the feature point as a center. The feature quantity generation processing unit 22 binarizes a luminance gradient between two pixels in the local region having the feature point as the center, and uses the binary information as a component of the feature quantities. Note that the feature quantity generation process is described below.

The matching point search processing unit 23 searches for feature quantities that are similar between images, and determines feature points whose feature quantities are most similar to be the matching points of the identical object. The components of the feature quantities are binary information. Thus, exclusive OR is computed for each component of the feature quantities. The result of the exclusive OR operation is, if the components are equal, “0,” and if the components are different, “1.” Thus, the matching point search processing unit 23 determines a feature point whose total value of the result of exclusive OR operation of each component is the smallest to be a feature point having the highest similarity.

The transformation matrix computation processing unit 24 determines an optimum Affine conversion matrix or projection transformation matrix (homography), which describes the relationship between the coordinate systems of the two images, from the coordinates of the feature point and the coordinates of the matching point obtained by the matching point search processing unit 23. Note that such a matrix will be referred to as an image transformation matrix. The transformation matrix computation processing unit 24, in determining an image transformation matrix, determines a more accurate image transformation matrix using a robust estimation method.

An example of the robust estimation method is determining an image transformation matrix using a RANSAC (RANdom SAmple Consensus) method. That is, pairs of feature points and matching points are randomly extracted to repeat computation of image transformation matrices. Then, among the computed image transformation matrices, an image transformation matrix containing the largest number of pairs of feature points and matching points is determined to be an accurate estimation result. For the robust estimation method, a method other than RANSAC may also be used.

As described above, when feature points whose feature quantities are similar are detected between images, it becomes possible to match identical objects from the correspondence relationship of the feature points. Thus, detection of identical objects becomes possible. In addition, when an image transformation matrix is determined from the correspondence relationship of the feature points, it becomes possible to transform the coordinate system of one image to the coordinate system of the other image using the image transformation matrix. Therefore, it is possible to, using a plurality of captured images, for example, generate a panoramic image by accurately joining the images such that the object image will have no missing parts or overlapping parts. In addition, when a plurality of captured images are generated, the images can be joined accurately even when the imaging device is tilted, for example. Further, as the identical objects can be matched, if an image transformation matrix that represents a global movement between two images is determined, it becomes possible to detect a subject that is moving locally, and thus extract a moving subject region. In addition, even in the codec processing for image data, the detection result of identical objects may be used. For example, on the basis of the detection result of identical objects, a global movement between two images may be determined, and the result may be used for the codec processing.

### <3. Feature Quantity Generation Process>

Next, a feature quantity generation process will be described. In the feature quantity generation process, two pixels at given coordinates are selected, and the difference between the pixel values of the two pixels is computed. The computation result is compared with a threshold, and binary information is generated on the basis of the comparison result and is used as a component of the feature quantities. In Formula (1), symbol “V” represents feature quantities (a feature vector), and symbols “V1 to Vn” represent the respective components of the feature quantities.

$$[ Formula 1 ]$$

$$\vec{v} = ( \begin{matrix}{v}_{1} \\ ⋮ \\ {v}_{n}\end{matrix} ) \qquad ( 1 )$$

The component “Vi” of the feature quantities is, as represented by Formula (2), determined as binary information by a function f from the pixel value I(pi) at the coordinate pi, the pixel value I(qi) at the coordinate qi, and a threshold thi. Note that the threshold thi need not be set for each coordinate pi, and a threshold that is common to each coordinate may also be used.

[Formula 2]

vᵢ=f(I(pᵢ),I(qᵢ),thᵢ) (2)

Formula (3) represents an example of the function f represented by Formula (2).

$$[ Formula 3 ]$$

$$f = \{ \begin{matrix}1 : I ( {p}_{i} ) - I ( {q}_{i} ) \geq {th}_{i} \\ 0 : I ( {p}_{i} ) - I ( {q}_{i} ) < {th}_{i}\end{matrix} \qquad ( 3 )$$

Provided that the threshold thi in the function represented by Formula (3) is “0,” if the difference between the pixel values of the two pixels is greater than or equal to “0,” the binary information “1” is used as a component of the feature quantities, and if the difference is a negative value, the binary information “0” is used as a component of the feature quantities. That is, when two pixels have no change in luminance or have an increasing luminance gradient, the value of the component of the feature quantities is “1.” Meanwhile, when two pixels have a decreasing luminance gradient, the value of the component of the feature quantities is “0.” Thus, even when normalization is not performed in accordance with the pixel values of the two pixels, feature quantities in accordance with the luminance gradient can be generated.

Next, variations of two pixels used to generate a component of feature quantities in the feature quantity generation process will be described.

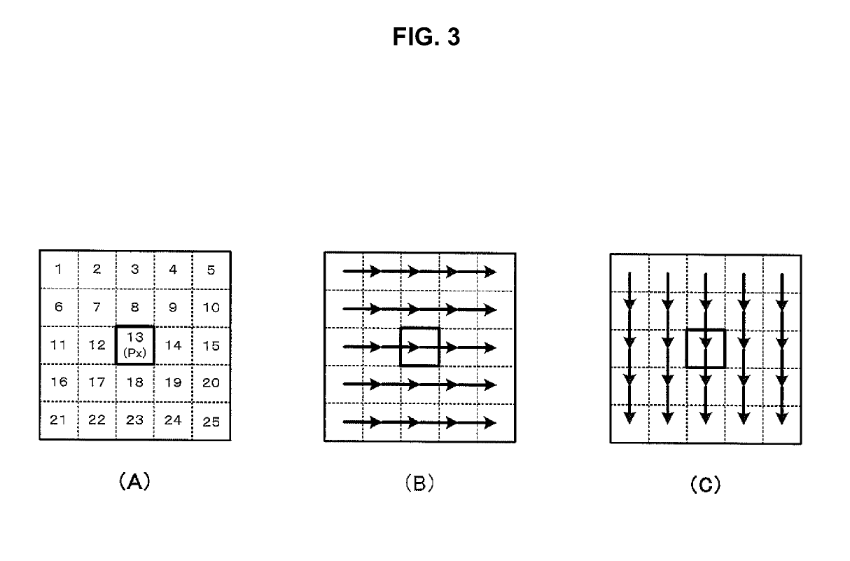

FIG. 3 shows a case where feature quantities are generated using each pixel in a rectangular local region. When generating feature quantities of a local region, a region of 5×5 pixels, which includes the coordinates detected as a feature point as a center, is used as shown in (A) in FIG. 3, for example. Note that numbers in the drawing indicate the identifiers IDs of the respective pixels, and the coordinates Px detected as a feature point are located at “13.” In addition, I(ID) is the pixel value of a pixel indicated by the identifier ID. For example, I(1) represents the pixel value of a pixel located at the upper left (ID=1).

When the function represented by Formula (3) is used as the function f, binary information is output depending on whether, provided that the threshold thi is “0,” the pixel difference value of the adjacent pixels is a positive value or a negative value, and such binary information is used as each component of the feature quantities. Note that in (B) and (C) in FIG. 3, each arrow indicates a pixel on the subtrahend side or a pixel on the minuend side in the subtraction computation, and the starting point of the arrow is I(pi), while the end point of the arrow is I(qi). Each component of the feature quantities in the case shown in (B) in FIG. 3 can be generated on the basis of Formula (4). Likewise, each component of the feature quantities in the case shown in (C) in FIG. 3 can be generated on the basis of Formula (5). Thus, in the case of the rectangular region shown in FIG. 3, feature quantities containing a total of 40 components can be generated.

[Formula 4]

vᵢ=f(I(pᵢ₊₀),I(qᵢ₊₁),0):i=1 . . . 4

vᵢ=f(I(pᵢ₊₁),I(qᵢ₊₂),0):i=5 . . . 8

vᵢ=f(I(pᵢ₊₂),I(qᵢ₊₃),0):i=9 . . . 12

vᵢ=f(I(pᵢ₊₃),I(qᵢ₊₄),0):i=13 . . . 16

vᵢ=f(I(pᵢ₊₄),I(qᵢ₊₅),0):i=17 . . . 20 (4)

v₂₀₊ᵢ=f(I(pᵢ₊₀),I(qᵢ₊₅),0):i=1 . . . 20 (5)

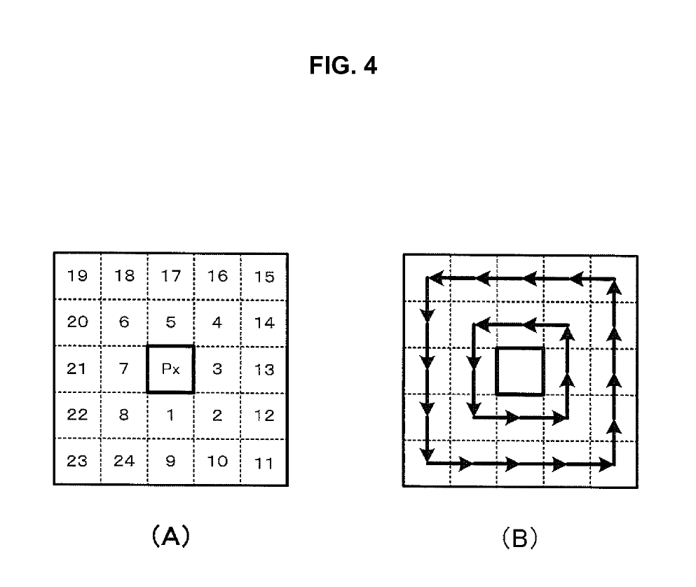

FIG. 4 shows another case where feature quantities are generated using each pixel in a rectangular local region. When generating feature quantities of a local region, a region of 5×5 pixels, which includes the coordinates Px detected as a feature point as a center, is used as shown in (A) in FIG. 4, for example. Note that the numbers in the drawing indicate the identifiers IDs of the respective pixels.

When the function represented by Formula (3) is used as the function f, binary information is output depending on whether the pixel difference value of pixels that are adjacent in the circumferential direction is a positive value or a negative value, and such binary information is used as each component of the feature quantities. Note that in (B) in FIG. 4, each arrow indicates a pixel on the subtrahend side or a pixel on the minuend side in the subtraction computation, and the starting point of the arrow is I(pi), while the end point of the arrow is I(qi). Thus, each component of the feature quantities in the case shown in (B) in FIG. 4 is generated as in FIG. 3. In the case of the rectangular region shown in FIG. 4, feature quantities containing a total of 25 components can be generated.

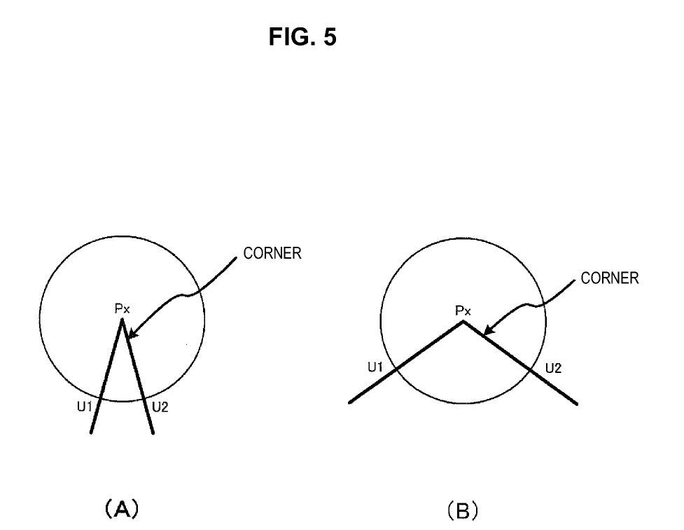

By the way, in the case shown in FIG. 3 or FIG. 4, the number of operations needed for the feature quantity generation process is large as the number of combinations of two pixels is large. Thus, combinations of two pixels that can reduce the number of operations needed for the feature quantity generation process will be described. For example, when a feature point is detected through corner detection, a circle having the feature point as a center intersects an edge representing a corner of the two points U1 and U2 even when the corner has an acute angle as shown in (A) in FIG. 5 or an obtuse angle as shown in (B) in FIG. 5. Thus, when feature quantities are generated from a rectangular local region using pixels along a circumference, it becomes possible to generate feature quantities representing a corner even if the number of combinations of two pixels is small, and thus, the number of operations needed for the feature quantity generation process can be reduced.

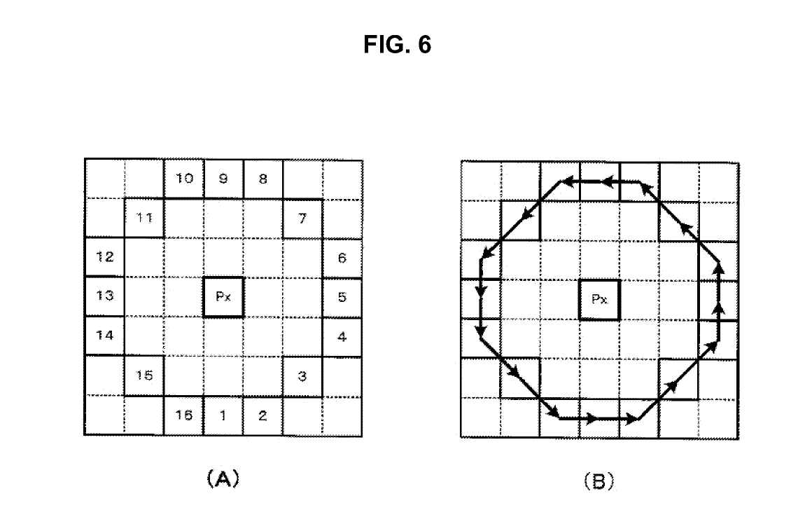

FIG. 6 is a diagram showing a case where feature quantities are generated from a rectangular local region using pixels along a circumference. For example, as shown in (A) in FIG. 6, in a region of 7×7 pixels, which includes the coordinates Px detected as a feature point as a center, 16 pixels along a circumference having the coordinates Px as a center are used. Note that the numbers in the drawing indicate the identifiers IDs of the respective pixels.

When the function represented by Formula (3) is used as the function f, binary information is output depending on whether the pixel difference value of pixels that are adjacent in the circumferential direction is a positive value or a negative value, and such binary information is used as each component of the feature quantities. Note that in (B) in FIG. 6, each arrow indicates a pixel on the subtrahend side or a pixel on the minuend side in the subtraction computation, and the starting point of the arrow is I(pi), while the end point of the arrow is I(qi). Thus, each component of the feature quantities in the case shown in (B) in FIG. 6 is generated on the basis of Formula (6). Thus, in the case shown in FIG. 6, feature quantities containing a total of 16 components can be generated.

[Formula 5]

vᵢ=f(I(pᵢ),I(qᵢ₊₁),0):i=1 . . . 15

vᵢ=f(I(pᵢ),I(qᵢ₋₁₅),0):i=16 (6)

Further, when the circle shown in FIG. 5 is multiplied, the number of portions in which the circles intersect the edge will increase. Thus, more accurate feature quantities can be generated.

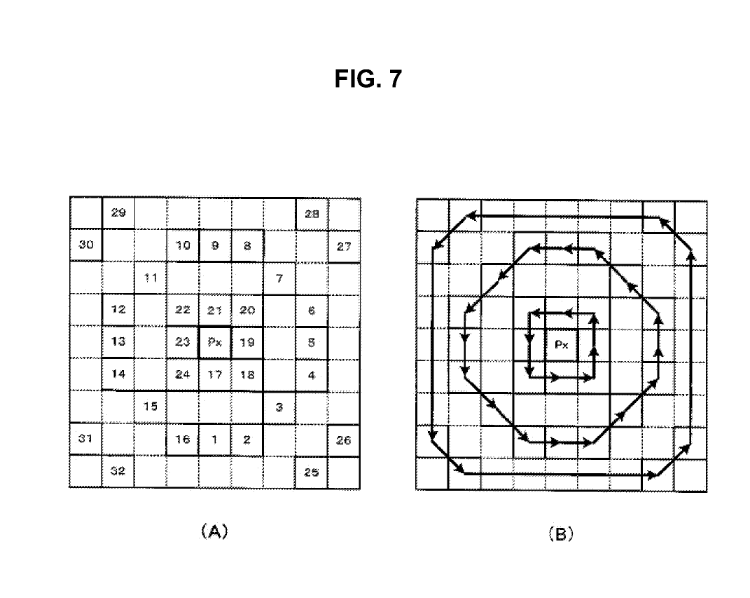

FIG. 7 shows a case where feature quantities are generated from a rectangular local region using pixels along multiple circumferences. When generating feature quantities of a local region, 32 pixels along multiple circumferences, which include the coordinates Px detected as a feature point as a center, are used as shown in (A) in FIG. 7. Note that the numbers in the drawing indicate the identifiers IDs of the respective pixels.

When the function represented by Formula (3) is used as the function f, binary information is output depending on whether the pixel difference value of pixels that are adjacent in the circumferential direction is a positive value or a negative value, and such binary information is used as each component of the feature quantities. Note that in (B) in FIG. 7, each arrow indicates a pixel on the subtrahend side or a pixel on the minuend side in the subtraction computation. Thus, in the case shown in FIG. 7, feature quantities containing a total of 32 components can be generated. In addition, in comparison with the case shown in FIG. 6, feature quantities can be generated more accurately.

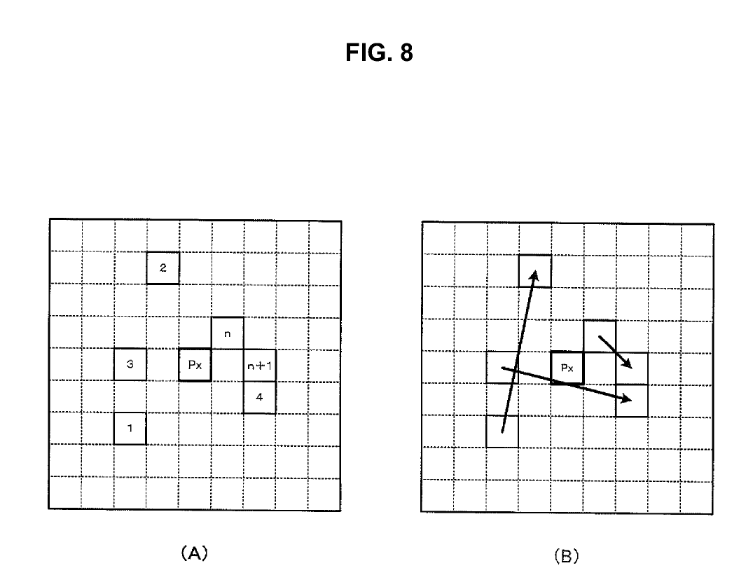

Further, although pixels are selected regularly in FIGS. 3, 4, 6, and 7, it is also possible to, for the pixels to be selected, select two points that are advantageously used to generate feature quantities through machine learning, or the two points and a threshold used to binarize the difference value of the two points. For example, as shown in FIG. 8, feature quantities may be generated using two pixels specified through learning.

The phrase “advantageously used to generate feature quantities” has two meanings. One meaning is that feature points representing identical portions can be represented by quantities that are close to each other even when conditions such as the brightness change. The other meaning is that feature points representing different portions can be represented by quantities that are far from each other. In machine learning, a method called Adaboost can be used as an example. For example, a large number of combinations of two points are prepared, and a large number of weak hypotheses are generated. Then, if the weak hypotheses are correct is determined. That is, it is determined through learning if a combination of two points is a combination that can generate feature quantities adapted to identify a point corresponding to the identical object. On the basis of the determination result, the weight of a correct combination is increased, and the weight of an incorrect combination is decreased. Further, if a desired number of combinations are selected in order of decreasing weight, it becomes possible to generate feature quantities containing a desired number of components.

FIG. 8 exemplarily shows a case where three combinations of two points are selected through machine learning. (A) in FIG. 8 shows pixel positions of combinations of two points selected through machine learning. In (B) in FIG. 8, each arrow indicates a pixel on the subtrahend side or a pixel on the minuend side in the subtraction computation. Thus, in the case shown in FIG. 8, feature quantities containing a total of three components can be generated. Note that when generating feature quantities containing n components, it is acceptable as long as n combinations of two points are selected in order of decreasing weight as described above.

As described above, two pixels at given coordinates are selected, and the difference between the pixel values of the two pixels is computed. The computation result is compared with a threshold, and binary information is generated on the basis of the comparison result so that the binary information is used as a component of the feature quantities. Thus, feature quantities used for matching identical objects between two pixels can be generated with high accuracy and with a low processing cost.

In addition, when feature quantities are generated with a threshold as “0,” the feature quantities will be constant with respect to a change in brightness. Thus, a normalization process becomes unnecessary and the computation cost can be reduced significantly.

Further, as each component of the feature quantities is binary information, if the feature quantities contain less than or equal to 32 components, packing can be performed in units of 32 bits, and if the feature quantities contain less than or equal to 64 components, packing can be performed in units of 64 bits. Thus, if writing of feature quantities to a memory unit or reading of feature quantities from the memory unit is performed in units of packing, the memory access time can be reduced. In addition, feature quantities can be efficiently stored into the memory unit.

When feature quantities are packed in units of 32 bits or 64 bits, a CPU (Central Processing Unit) or a DSP (Digital Signal Processor), which can execute an instruction for computing exclusive OR or an instruction for counting a bit number “1” of the logical operation result, is used. When such a CPU or DSP is used, the similarity of feature quantities can be computed very quickly.

A series of processes described in this specification can be executed by any of hardware, software, or both. When a process is executed by software, a program having a processing sequence recorded thereon is installed on memory in a computer, which is built in dedicated hardware, and is then executed. Alternatively, a program can be installed on a general-purpose computer that can execute various processes, and then executed.

For example, the program can be recorded on a hard disk or ROM (Read Only Memory) as a recording medium in advance. Alternatively, the program can be temporarily or permanently stored (recorded) in (on) a removable recording medium such as a flexible disk, CD-ROM (Compact Disc Read Only Memory), MO (Magneto Optical) disk, DVD (Digital Versatile Disc), a magnetic disk, or a semiconductor memory card. Such a removable recording medium can be provided as so-called package software.

In addition, the program can be, not only installed on a computer from a removable recording medium, but also transferred wirelessly or by wire to the computer from a download site via a network such as a LAN (Local Area Network) or the Internet. In such a computer, a program transferred in the aforementioned manner can be received and installed on a recording medium such as built-in hardware.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing device including:

a feature point detection processing unit configured to detect a feature point from an image; and

a feature quantity generation processing unit configured to compare a pixel difference value of two pixels in an image region having a position of the detected feature point as a reference with a threshold and generate binary information indicating a result of comparison as a component of feature quantities corresponding to the feature point.

(2)

The image processing device according to (1), wherein the feature quantity generation processing unit compares a pixel difference value of two pixels specified in advance in the image region with the threshold.

(3)

The image processing device according to (2), wherein the feature quantity generation processing unit compares a pixel difference value of two adjacent pixels with the threshold.

(4)

The image processing device according to (3), wherein the feature quantity generation processing unit compares a pixel difference value of two adjacent pixels with the threshold, the two adjacent pixels being located along a circumference having the position of the feature point as a center.

(5)

The image processing device according to (2), wherein the feature quantity generation processing unit compares a pixel difference value of two pixels with the threshold, the two pixels being located at positions determined in advance through learning in the pixel region.

(6)

The image processing device according to any one of (2) to (5), wherein the feature quantity generation processing unit sets the threshold to be compared with the pixel difference value of the two pixels to “0.”

(7)

The image processing device according to any one of (1) to (6), further including a matching point search processing unit configured to, for a feature point detected from a first image, search for feature quantities that are most similar to feature quantities corresponding to the feature point from among feature quantities corresponding to feature points detected from a second image, thereby detecting a feature point in the second image corresponding to the feature point detected from the first image.

(8)

The image processing device according to any one of (1) to (7), wherein

the matching point search processing unit performs an exclusive OR operation of the feature quantities corresponding to the feature point detected from the first image and the feature quantities corresponding to the feature point detected from the second image, and searches for feature quantities that are most similar on the basis of the operation result.

(9)

The image processing device according to any one of (1) to (8), further including a transformation matrix computation unit configured to compute a transformation matrix for performing image transformation between the first image and the second image from a correspondence relationship between the feature point detected from the first image and the feature point in the second image corresponding to the feature point detected from the first image.

(10)

The image processing device according to any one of (1) to (9), wherein the transformation matrix computation unit computes the transformation matrix using robust estimation.

According to the image processing device, the image processing method, and the program of the present technology, a feature point is detected from an image. Then, a pixel difference value of two pixels in an image region, which has the position of the detected feature point as a reference, is compared with a threshold, and binary information representing the result of comparison is generated as a component of the feature quantities corresponding to the feature point. Therefore, it becomes possible to generate feature quantities used for matching identical objects between two images with high accuracy and with a low processing cost. Thus, it is possible to easily search for identical objects from a plurality of images. In addition, it is also possible to easily generate a panoramic image by accurately joining images such that the object image will have no missing parts or overlapping parts. Further, it also becomes possible to extract a moving subject region. In addition, the result can also be used for the codec processing for image data.

The present application contains subject matter related to that disclosed in Japanese Priority Patent Application JP 2011-100835 filed in the Japan Patent Office on Apr. 28, 2011, the entire content of which is hereby incorporated by reference.

What is claimed is:

1. An image processing device comprising:
a feature point detection processing unit configured to detect a feature point from an image; and
a feature quantity generation processing unit configured to compare a pixel difference value of two pixels in an image region having a position of the detected feature point as a reference with a threshold and generate binary information indicating a result of comparison as a component of feature quantities corresponding to the feature point.

2. The image processing device according to claim 1, wherein the feature quantity generation processing unit compares a pixel difference value of two pixels specified in advance in the image region with the threshold.

3. The image processing device according to claim 2, wherein the feature quantity generation processing unit compares a pixel difference value of two adjacent pixels with the threshold.

4. The image processing device according to claim 3, wherein the feature quantity generation processing unit compares a pixel difference value of two adjacent pixels with the threshold, the two adjacent pixels being located along a circumference having the position of the feature point as a center.

5. The image processing device according to claim 2, wherein the feature quantity generation processing unit compares a pixel difference value of two pixels with the threshold, the two pixels being located at positions determined in advance through learning in the pixel region.

6. The image processing device according to claim 2, wherein the feature quantity generation processing unit sets the threshold to be compared with the pixel difference value of the two pixels to “0.”

7. The image processing device according to claim 1, further comprising a matching point search processing unit configured to, for a feature point detected from a first image, search for feature quantities that are most similar to feature quantities corresponding to the feature point from among feature quantities corresponding to feature points detected from a second image, thereby detecting a feature point in the second image corresponding to the feature point detected from the first image.

8. The image processing device according to claim 7, wherein
the matching point search processing unit performs an exclusive OR operation of the feature quantities corresponding to the feature point detected from the first image and the feature quantities corresponding to the feature point detected from the second image, and searches for feature quantities that are most similar on the basis of the operation result.

9. The image processing device according to claim 7, further comprising a transformation matrix computation unit configured to compute a transformation matrix for performing image transformation between the first image and the second image from a correspondence relationship between the feature point detected from the first image and the feature point in the second image corresponding to the feature point detected from the first image.

10. The image processing device according to claim 9, wherein the transformation matrix computation unit computes the transformation matrix using robust estimation.

11. An image processing method comprising:
detecting a feature point from an image; and
comparing a pixel difference value of two pixels in an image region having a position of the detected feature point as a reference with a threshold, and generating binary information indicating a result of comparison as a component of feature quantities corresponding to the feature point.

12. A program for causing a computer to execute the procedures of:
detecting a feature point from an image; and
comparing a pixel difference value of two pixels in an image region having a position of the detected feature point with a threshold, and generating binary information indicating a result of comparison as a component of feature quantities corresponding to the feature point.
